(19) United States
(12) Patent Application Publication
(10) Pub. No.: US 2024/0361681 A1
(43) Pub. Date: Oct. 31, 2024

(54) PROJECTION DEVICE

(71) Applicant: Coretronic Corporation, Hsin-Chu (TW)

(72) Inventors: Wei-Ting Wu, Hsin-Chu (TW); Wen-Chun Wang, Hsin-Chu (TW); Ching-Chuan Wei, Hsin-Chu (TW); You-Da Chen, Hsin-Chu (TW); Chun-An Wei, Hsin-Chu (TW); Yi-En Hsu, Hsin-Chu (TW)

(73) Assignee: Coretronic Corporation, Hsin-Chu (TW)

(21) Appl. No.: 18/645,365

(22) Filed: Apr. 24, 2024

Related U.S. Application Data
(60) Provisional application No. 63/461,600, filed on Apr. 25, 2023.

(30) Foreign Application Priority Data
Jun. 29, 2023 (CN) 202310780768.4
Feb. 7, 2024 (CN) 202410174670.9

(51) Int. Cl. G03B 21/28; G02B 3/08; G02B 5/10

(52) U.S. Cl. CPC G03B 21/28; G02B 3/08; G02B 5/10

(57) ABSTRACT

A projection device including an imaging module, a freeform-surface reflective mirror, and a projection lens assembly is provided. The imaging module is configured to provide imaging beams and includes a display panel and a light-source module. The imaging beams are transmitted toward the projection lens assembly by the freeform-surface reflective mirror. The projection lens assembly includes a first optical axis and a second optical axis. The first optical axis passes through the projection lens assembly. The imaging beams emitted by the projection device form an imaging-beam region, in which the first optical axis does not pass through a geometric center of the imaging-beam region, and the second optical axis passes through a geometric center region of the display panel. The geometric center region is a region having a distance less than or equal to 40% of a minimum width of the display panel from a geometric center of the display panel.

### CROSS-REFERENCE TO RELATED APPLICATION

This application claims the priority benefits of U.S. provisional application Ser. No. 63/461,600, filed on Apr. 25, 2023, China application serial no. 202310780768.4, filed on Jun. 29, 2023, and China application serial no. 202410174670.9, filed on Feb. 7, 2024. The entirety of each of the above-mentioned patent applications is hereby incorporated by reference herein and made a part of this specification.

### BACKGROUND

### Technical Field

The disclosure relates to an optical device, and particularly relates to a projection device.

### Description of Related Art

For traditional LCD projection devices, due to the large size of the image source (i.e. LCD), the overall projection lens assembly is large in size and weight. In order to reduce the size and weight, the lens element in the projection lens assembly and the image source are configured in a manner that is not off-axis. However, the projection device configured as above needs to be elevated to prevent the projected image from being blocked, which reduces the degree of freedom in use. In the existing technology, if the relative position of the lens element in the projection lens assembly and the image source are configured in a manner that is off-axis, this increases the size and weight of the projection lens assembly. If the off-axis configuration is replaced by tilting the projection lens assembly, then the trapezoidal distortion, barrel distortion, and pincushion distortion of the image may be caused, and the resolution is degraded.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

In order to achieve one, part of, or all of the purposes or other purposes, according to an embodiment of the disclosure, a projection device is provided, including an imaging module, a freeform-surface reflective mirror, and a projection lens assembly. The imaging module includes a display panel and a light-source module. The imaging module is configured to provide imaging beams. The freeform-surface reflective mirror is disposed on a path of the imaging beams. The imaging beams are transmitted toward the projection lens assembly via the freeform-surface reflective mirror and emitted by the projection device after passing through the projection lens assembly. The projection lens assembly has an optical axis, and the optical axis includes a first optical axis and a second optical axis. The second optical axis deflects relative to the first optical axis at the freeform-surface reflective mirror. The first optical axis passes through the projection lens assembly. The imaging beams emitted by the projection device form an imaging-beam region on a cross-section plane perpendicular to the first optical axis. The first optical axis does not pass through a geometric center of the imaging-beam region, and the second optical axis passes through a geometric center region of the display panel. The geometric center region is a region having a distance less than or equal to 40% of a minimum width of the display panel from a geometric center of the display panel.

In order to make the above-mentioned features and advantages of the disclosure more comprehensible, the embodiments are described in detail below in detail with accompanying drawings.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram of a status of use of a projection device according to an embodiment of the disclosure.

FIG. 1B is a schematic side-view diagram of the projection device in accordance with the first embodiment of the disclosure.

FIG. 1C is a schematic diagram of the configuration of the display panel in FIG. 1B.

FIG. 1D is a schematic diagram of a curved surface shape of a freeform-surface reflective mirror in FIG. 1B.

FIG. 1E is a schematic diagram of an imaging-beam region generated by the projection device in FIG. 1B.

FIG. 2 is a schematic side-view diagram of a status of use of a projection device according to a comparative example.

FIG. 3 is a schematic side-view diagram of a projection device according to the second embodiment of the disclosure.

FIG. 4A and FIG. 4B are respectively schematic diagrams of a field curvature aberration in a tangential direction and a field curvature aberration in a sagittal direction of the projection device according to the first embodiment of the disclosure.

FIG. 4C is a schematic diagram of a distortion aberration of the projection device according to the first embodiment of the disclosure.

FIG. 5A is a schematic diagram of a TV distortion of a projection device according to a comparative example, and FIG. 5B is a schematic diagram of a TV distortion of the projection device according to the first embodiment of the disclosure.

FIG. 6A is a schematic diagram of MTF (modulation transfer function) at multiple field of view angles of the projection device according to the first embodiment of the disclosure.

FIG. 6B is a schematic diagram of lateral chromatic aberration of the projection device according to the first embodiment of the disclosure.

FIG. 7A is a schematic side-view diagram of the projection device in accordance with the third embodiment of the disclosure.

FIG. 7B is a schematic diagram of the configuration of the display panel in FIG. 7A.

FIG. 7C is a schematic diagram of an imaging-beam region generated by the projection device in FIG. 7A.

FIG. 8A and FIG. 8B are respectively schematic diagrams of a field curvature aberration in a tangential direction and a field curvature aberration in a sagittal direction of the projection device according to the third embodiment of the disclosure.

FIG. 8C is a schematic diagram of a distortion aberration of the projection device according to the third embodiment of the disclosure.

FIG. 9A is a schematic diagram of MTF (modulation transfer function) at multiple field of view angles of the projection device according to the third embodiment of the disclosure.

FIG. 9B is a schematic diagram of lateral chromatic aberration of the projection device according to the third embodiment of the disclosure.

FIG. 10A and FIG. 10B are schematic diagrams of a status of use of a projection device according to an embodiment of the disclosure.

FIG. 11A is a schematic top-view diagram of the projection device in accordance with the fourth embodiment of the disclosure.

FIG. 11B is a schematic diagram of the configuration of the display panel in FIG. 11A.

FIG. 11C is a schematic diagram of an imaging-beam region generated by the projection device in FIG. 11A.

FIG. 12A and FIG. 12B are respectively schematic diagrams of a field curvature aberration in a tangential direction and a field curvature aberration in a sagittal direction of the projection device according to the fourth embodiment of the disclosure.

FIG. 12C is a schematic diagram of a distortion aberration of the projection device according to the fourth embodiment of the disclosure.

FIG. 13A is a schematic diagram of MTF (modulation transfer function) at multiple field of view angles of the projection device according to the fourth embodiment of the disclosure.

FIG. 13B is a schematic diagram of lateral chromatic aberration of the projection device according to the fourth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The aforementioned and other technical contents, features, and effects according to the disclosure will be clearly presented in the following detailed description of a preferred embodiment with reference to the drawings. Directional terms mentioned in the following embodiments, such as up, down, left, right, front, or back, are merely for reference to the direction of the accompanying drawings. Therefore, the directional terms used are merely for illustrative purposes and the disclosure is not limited thereto.

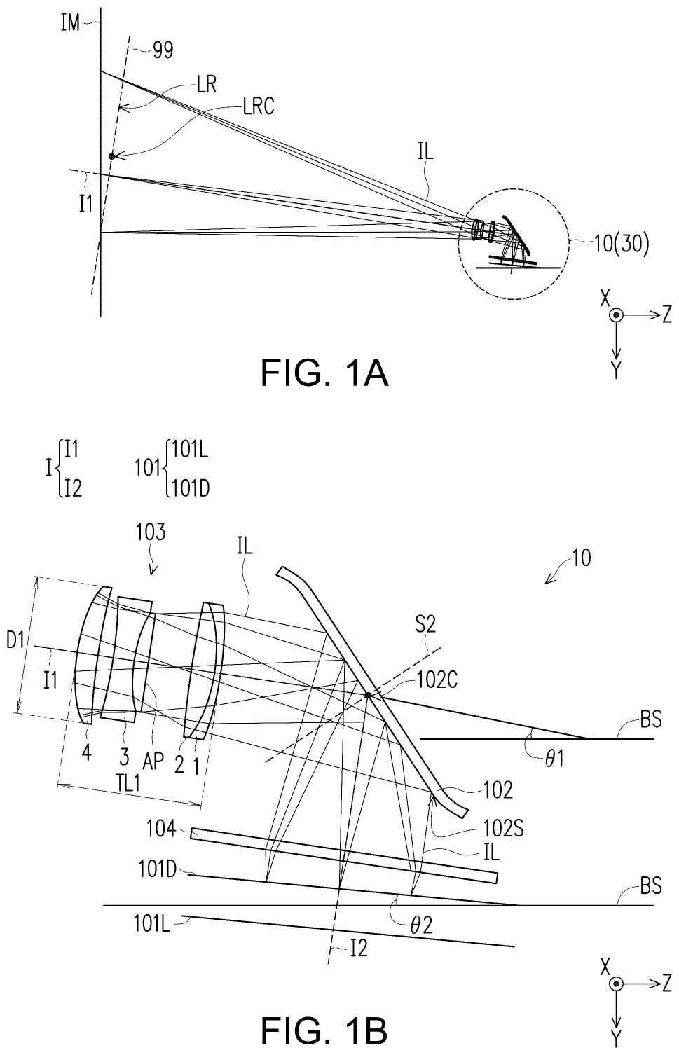

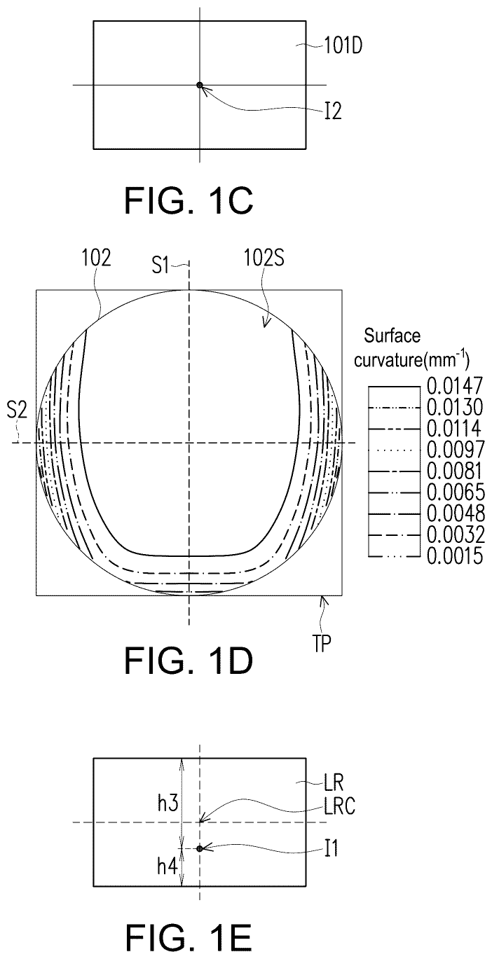

FIG. 1A is a schematic diagram of a status of use of a projection device according to an embodiment of the disclosure. FIG. 1B is a schematic structural diagram of the projection device in accordance with the first embodiment of the disclosure. FIG. 1C is a schematic diagram of a configuration of a display panel in FIG. 1B. FIG. 1D is a schematic diagram of a curved surface shape of a freeform-surface reflective mirror in FIG. 1B. FIG. 1E is a schematic diagram of an imaging-beam region generated by the projection device in FIG. 1B. Please refer to FIG. 1A to FIG. 1E. According to the first embodiment of the disclosure, a projection device 10 including an imaging module 101, a freeform-surface reflective mirror 102, and a projection lens assembly 103 is provided. The imaging module 101 includes a display panel 101D and a light-source module 101L, in which the display panel 101D is disposed between the light-source module 101L and the freeform-surface reflective mirror 102. The imaging module 101 is used to provide imaging beams IL. The freeform-surface reflective mirror 102 is disposed on the path of the imaging beams IL. The imaging beams IL is transmitted toward the projection lens assembly 103 by the freeform-surface reflective mirror 102 and transmitted out the projection device 10 after passing through the projection lens assembly 103.

The projection lens assembly 103 has an optical axis I. The optical axis I includes a first optical axis I1 and a second optical axis I2. The second optical axis I2 deflects relative to the first optical axis I1 at the freeform-surface reflective mirror 102 (for example, the second optical axis I2 deflects relative to the first optical axis I1 at a geometric center 102C of the freeform-surface reflective mirror 102, but the disclosure is not limited thereto. In other embodiments, the deflection point of the optical axis I may be on a proper position on the reflection surface of the freeform-surface reflective mirror 102), which means that the first optical axis I1 is a part of the optical axis I before the deflection, and the second optical axis I2 is a part of the optical axis I after the deflection at the freeform-surface reflective mirror 102. The first optical axis I1 passes through the projection lens assembly 103 (e.g., the first optical axis I1 is passes through a center of lenses of the projection lens assembly 103) and is selectively tilted by an angle θ1 relative to a base surface BS. The base surface BS may be, for example, a horizontal plane parallel to the X-Z plane (a plane perpendicular to the direction of gravity, for example, suitable for an upright-type projection mode or configuration), or a plane parallel to a base plate of the projection device 10, in which the light-source module 101L is disposed on the base plate. A plane on which the display panel 101D (for example, a display surface of the display panel 101D, wherein the display surface is for example a region of the display panel 101D, through which beams emitted by the light-source module 101L may penetrate, so as to convert the illuminating beams into imaging beams) is positioned is selectively tilted by an angle θ2 relative to the base surface BS. In an embodiment, the base plate is perpendicular to, for example, a projection surface IM (e.g., a projection screen) parallel to the X-Y plane, but the disclosure is not limited thereto.

The freeform-surface reflective mirror 102 according to the disclosure has a free-form reflection surface 102S, which improves the degree of design freedom and optimizes the image quality of the projection device 10.

Specifically, please refer to FIG. 1B together with FIG. 1D. Different positions on the reflection surface 102S may have different relative heights, and the freeform-surface reflective mirror 102 is symmetrical with respect to a first plane S1 and asymmetrical with respect to a second plane S2, which means that the reflection surface 102S of the freeform-surface reflective mirror 102 is non-planar, in which the first plane S1 in FIG. 1D is the paper surface of FIG. 1B, the first optical axis I1 and the second optical axis I2 are positioned on the first plane S1, and the second plane S2 is perpendicular to the first plane S1 and perpendicular to a tangent plane TP of the geometric center 102C of the reflection surface 102S. In an embodiment, the first plane S1 is, for example, perpendicular to the base surface BS. It should be noted that, in an embodiment, a height of a portion of the reflection surface 102S on a side away from the display panel 101D is greater than a height of another portion of the reflection surface 102S on a side close to the display panel 101D relative to the tangent plane TP. Accordingly, when the imaging beams IL emitted by the projection device 10 forms an imaging-beam region LR on a cross-section plane 99 perpendicular to the first optical axis I1, the first optical axis I1 may not pass through a geometric center LRC of the imaging-beam region LR, as shown in FIG. 1A and FIG. 1E, a height h3 of the imaging-beam region LR above the first optical axis I1 is greater than a height h4 of the imaging-beam region LR below the first optical axis I1 (for example, in a direction parallel to the second optical axis I2), and this is the modification to the imaging beams IL via the tilt angle θ1 of the first optical axis I1, the tilt angle θ2 of the display panel 101D and the design of the freeform-surface reflective mirror 102. That is to say, when the projection device 10 according to this embodiment is used to generate an image projected onto the projection surface IM (the projection screen), the distortion of projected image caused by the tilt of the first optical axis I1 and the tilt of the display panel 101D relative to the base surface BS would be compensated by the modification to the imaging beams IL via the freeform-surface reflective mirror 102. Moreover, through the above configuration, the second optical axis I2 can be maintained passing through the geometric center of the display panel 101D, as shown in FIG. 1B and FIG. 1C (the paper surface of FIG. 1C is, for example, perpendicular to the second optical axis I2, but the display panel 101D is not necessarily to be perpendicular to the second optical axis I2), so as to avoid increasing the size of the projection lens assembly, and simultaneously avoid the problems of distortion of projected image and resolution degradation.

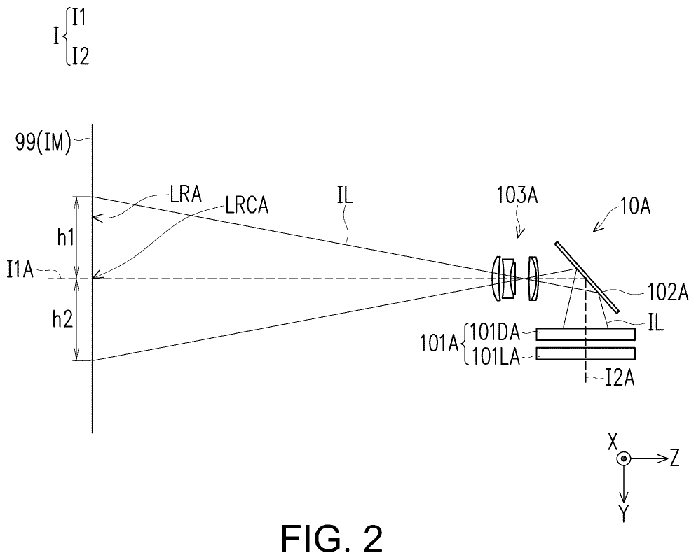

Furthermore, FIG. 2 is a schematic diagram of a status of use of a projection device according to a comparative example. Referring to FIG. 2, a projection device 10A includes an imaging module 101A, a plane reflective mirror 102A, and a projection lens assembly 103A. The imaging module 101A includes a light-source module 101LA and a display panel 101DA. The display panel 101DA and a first optical axis I1A of the projection lens assembly 103A are both parallel to the horizontal plane. The imaging beam IL generated by the projection device 10A forms an imaging-beam region LRA on the cross-section plane 99 perpendicular to the first optical axis I1, and the first optical axis I1 passes through a geometric center LRCA of the imaging-beam region LRA. As shown in FIG. 2, a height h1 of the imaging-beam region LRA above the first optical axis I1A is equal to a height h2 of the imaging-beam region LRA below the first optical axis I1.

Since the cross-section plane 99 is parallel to the projection surface IM, and the imaging-beam region LRA is symmetrically configured relative to the first optical axis I1A, the projection device 10A of the comparative example in FIG. 2 needs to be elevated to a specific height for use to be suitable for the user to watch the projected image of the imaging-beam region LRA, resulting in usage restrictions. To the contrary, the first optical axis I1 and the display panel 101D of the projection device 10 according to the disclosure are not parallel to the horizontal plane, and the freeform-surface reflective mirror 102 is provided. Therefore, there is no need to be elevated for use like the projection device 10A of the comparative example. That is to say, the projection device 10 according to the embodiment of the disclosure has a greater freedom of use than the projection device 10A of the comparative example. In addition, since the freeform-surface reflective mirror 102 according to the embodiment of the disclosure provides a great degree of design freedom, the display panel 101D and the projection lens assembly 103 may be symmetrically configured relative to the optical axis I, for example, each of multiple lens elements of the projection lens assembly 103 is symmetrically configured relative to the first optical axis I1, which reduces the size, weight, manufacturing difficulty, and manufacturing cost of the projection device 10.

Further, please refer to FIG. 1A to FIG. 1E. In the projection device 10 of the disclosure, the angle θ1 at which the first optical axis I1 is tilted relative to the base surface BS and the angle θ2 at which the plane where the display panel 101D is positioned is tilted relative to the base surface BS satisfies the conditional expression 0.7<|θ1/θ2|<1.5. In some embodiments, the angle θ1 and the angle θ2 satisfy the conditional expression 0.7<|θ1/(η2/2)|<1.5. In some embodiments, the angle θ1 is within a range of 0.5 degrees to 6 degrees, and the angle θ2 is within a range of 0.5 degrees to 7.5 degrees. In some embodiments, the difference between the angle θ1 and the angle θ2 (for example, the included angle between the first optical axis I1 and the plane on which the display panel 101D is located) is greater than −4 degrees and less than 4 degrees. In a preferred embodiment, the angle θ1 is not equal to the angle θ2. For example, the difference between the angle θ1 and the angle θ2 is greater than −4 degrees and less than 0.5 degrees, or greater than 0.5 degrees and less than 4 degrees. Specifically, the projection device 10 may also include a Fresnel lens element 104, which is disposed between the display panel 101D and the freeform-surface reflective mirror 102. The projection device 10 is, for example, a telecentric system. The optical axis of the Fresnel lens element 104 is parallel to the second optical axis I2 (that is, the first optical axis I1 and the second optical axis I2 each have an included angle of 45 degrees with the normal line of the freeform-surface reflective mirror 102, wherein the normal line of the freeform-surface reflective mirror 102 is, for example, the normal line of the tangent plane of the deflection point of the optical axis I on the reflection surface of the freeform-surface reflective mirror 102). In some embodiments, the included angle between the first optical axis I1 and the normal line of the freeform-surface reflective mirror 102 is within a range of 20 degrees to 65 degrees. In some embodiments, the included angle between the plane where the Fresnel lens element 104 (for example, the light-emitting surface) is positioned and the plane where the display panel 101D (for example, the display surface) is positioned is greater than −30 degrees and less than 30 degrees. In other embodiments, the plane where the Fresnel lens element 104 (for example, the light-emitting surface) is positioned is parallel to the plane where the display panel 101D (for example, the display surface) is positioned.

Referring again to FIG. 1B and FIG. 1D, in this embodiment, the included angle between the second optical axis I2 and the tangent plane TP of the geometric center 102C of the reflection surface 102S of the freeform-surface reflective mirror 102 is within a range of greater than or equal to 20 degrees or less than or equal to 60 degrees, for example, 45 degrees. That is to say, when a light beam is incident on the geometric center 102C of the freeform-surface reflective mirror 102 along the second optical axis I2, the light beam is incident on the reflection surface 102S at an incident angle of 45 degrees. However, the disclosure is not limited thereto, and the included angle may be changed according to the structure of the projection device 10.

For example, the projection lens assembly 103 includes a first lens element 1, a second lens element 2, a third lens element 3, and a fourth lens element 4 in a sequence from the object side to the image side (for example, the projection lens assembly 103 is composed of the first lens element 1, the second lens element 2, the third lens element 3, and the fourth lens element 4), and the first lens element 1 and the second lens element 2 are formed as a glued lens element. In this way, through gluing two lens elements with different refractive indexes, the chromatic aberration can be effectively eliminated, but not limited thereto. The stop AP is located between the second lens element 2 and the third lens element 3, and the stop AP is, for example, located where the diameter of the imaging beam IL is minimal in the projection lens assembly 103. It should be noted that, since the projected off-axis image is achieved through the tilt arrangement of the projection lens assembly 103 and the display panel 101D according to the disclosure, the proportional relationship between the size of the lens elements and the length of the projection lens assembly 103 may be maintained. For example, a distance between an object side of the first lens element 1 and an image side of the fourth lens element 4 on the first optical axis I1 is TL1, a diameter of the one with the largest diameter among the first lens element 1 to the fourth lens element 4 is D1, and the projection lens assembly 103 satisfies the conditional expression 0.7<ITL1/D1|<1.5.

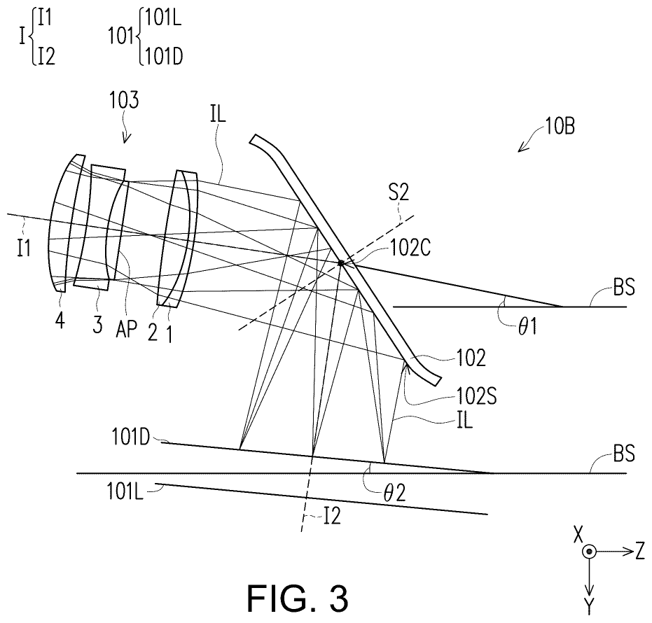

It should be noted that, the disclosure is not only suitable for the telecentric system shown in FIG. 1A and FIG. 1B, but also suitable for different optical systems. FIG. 3 is a schematic structural diagram of a projection device according to the second embodiment of the disclosure. Please refer to FIG. 3. The difference between this embodiment and the embodiment shown in FIG. 1B is that the Fresnel lens element 104 is not provided, so a projection device 10B of this embodiment is a non-telecentric system.

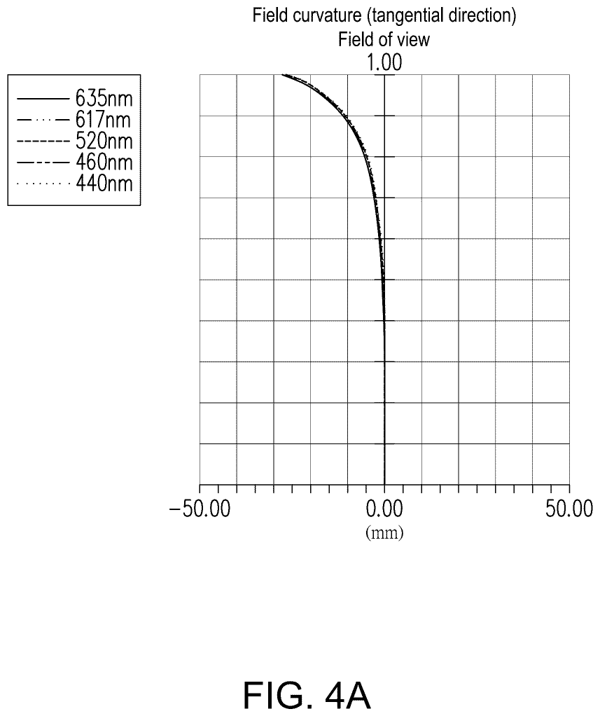

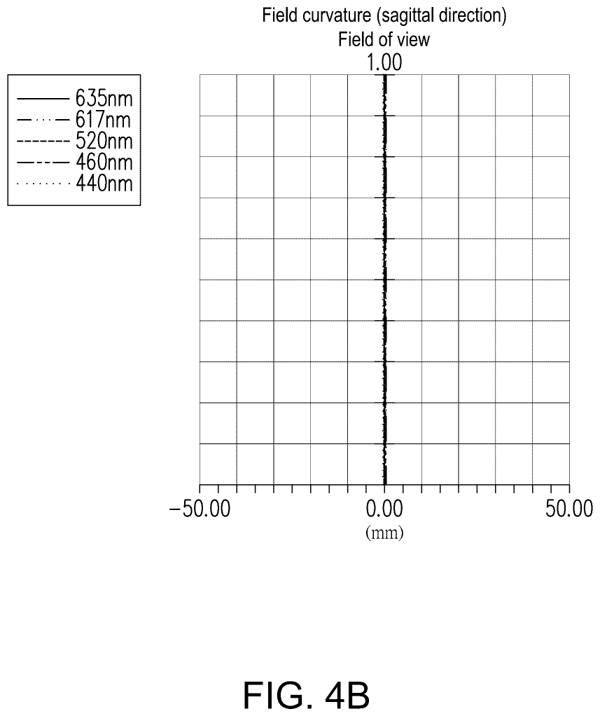

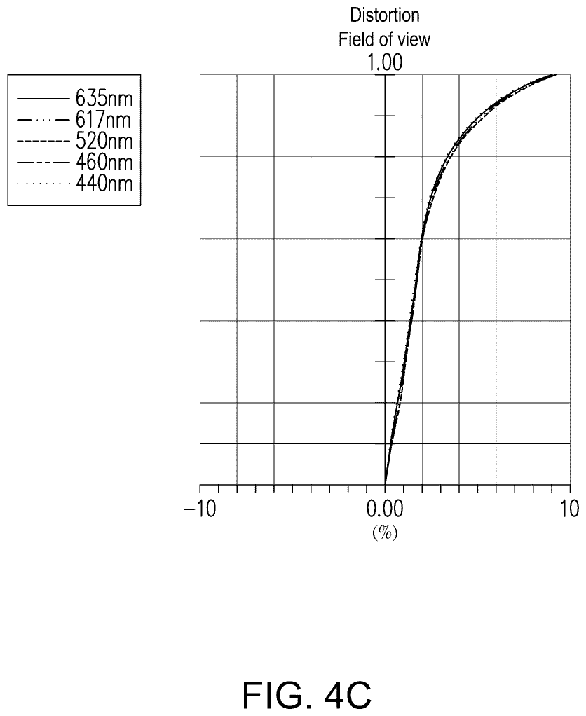

Referring to FIG. 4A, FIG. 4B, and FIG. 4C, FIG. 4A and FIG. 4B are respectively schematic diagrams of a field curvature aberration in a tangential direction and a field curvature aberration in a sagittal direction of the projection device 10 with wavelengths of 635 nm, 617 nm, 520 nm, 460 nm, and 440 nm. FIG. 4C is a schematic diagram of a distortion aberration of the projection device 10 with wavelengths of 635 nm, 617 nm, 520 nm, 460 nm, and 440 nm. In the two field curvature aberration diagrams (FIG. 4A and FIG. 4B), the field curvature aberration of the five representative wavelengths are within a range of ±30 mm for the entire field of view, indicating that the projection device 10 can effectively eliminate the field curvature aberration. The distortion aberration diagram in FIG. 4C shows that the distortion aberration is maintained within a range of ±10%, indicating that the projection device 10 can provide a good image quality.

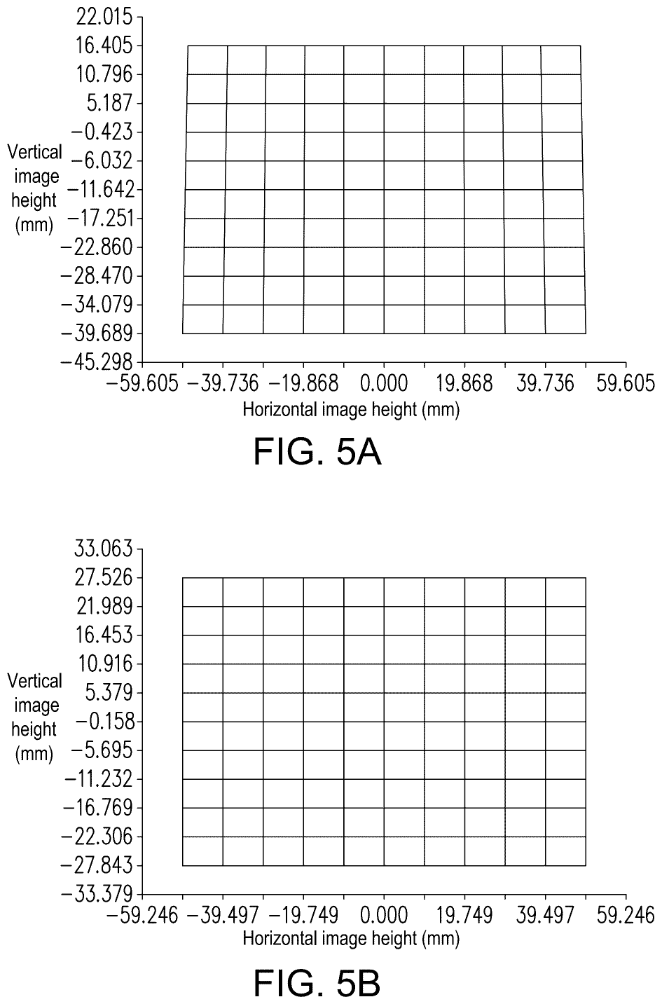

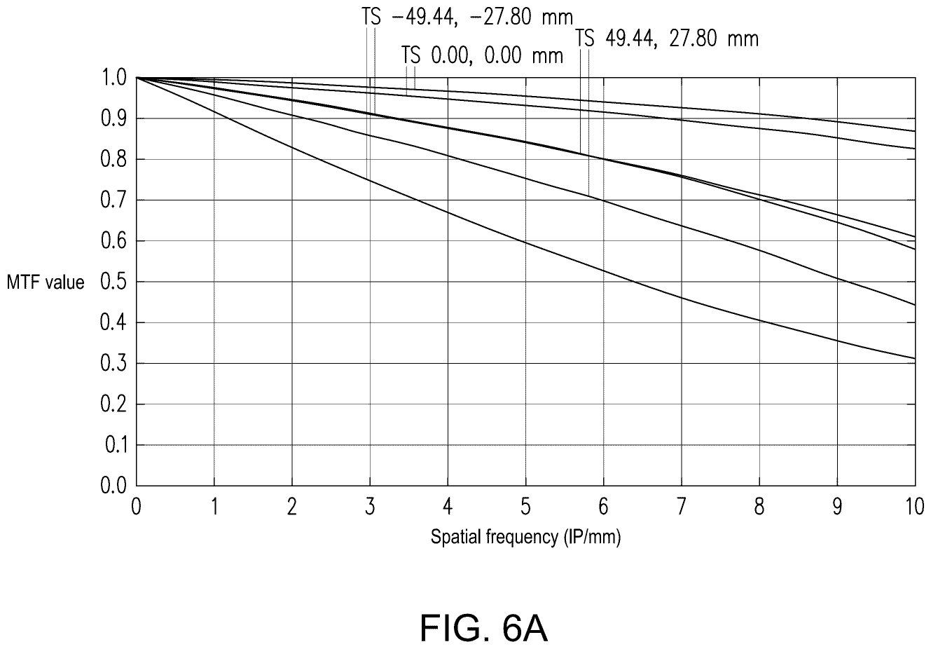

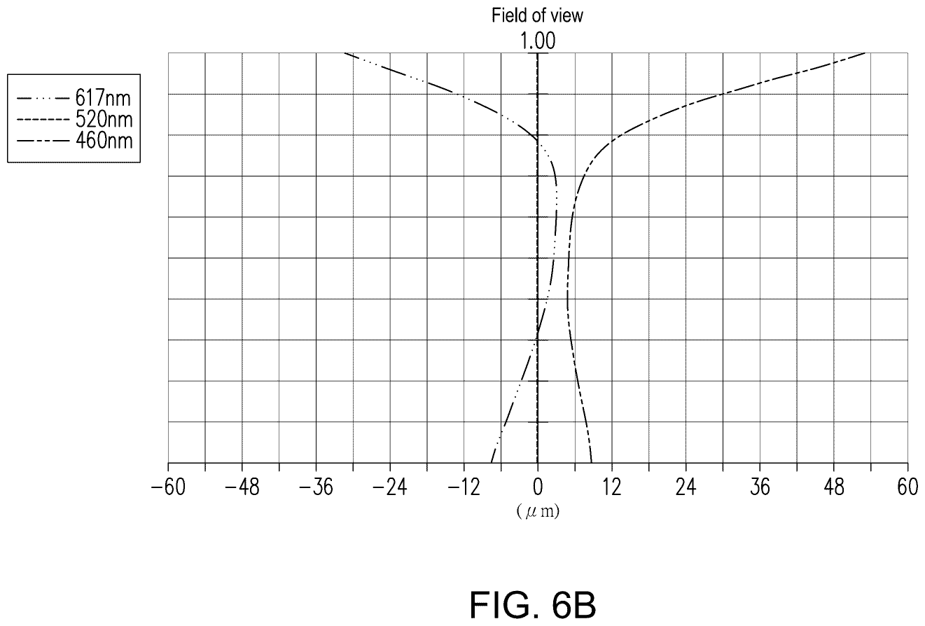

Referring to FIG. 5A and FIG. 5B, FIG. 5A is a schematic diagram of a TV distortion of a projection device according to a comparative example, and FIG. 5B is a schematic diagram of a TV distortion of the projection device according to the first embodiment of the disclosure. According to the comparison between FIG. 5A and FIG. 5B, it may be seen that the TV distortion of the projection device according to the embodiment of the disclosure is small, and a good optical performance is provided. Referring to FIG. 6A, which is a schematic diagram of MTF (modulation transfer function) at multiple positions (for example, a center position, a lower left position, and an upper right position) of the projection device according to the first embodiment of the disclosure. It is seen that the MTF value at each position of the projection device 10 according to the first embodiment of the disclosure is greater than 0.3, and a good optical performance is provided. Refer to FIG. 6B, which is a schematic diagram of lateral chromatic aberration of the projection device 10 according to the first embodiment of the disclosure. As shown in FIG. 6B, the maximum displacement of the red rays and the blue rays is 85 μm.

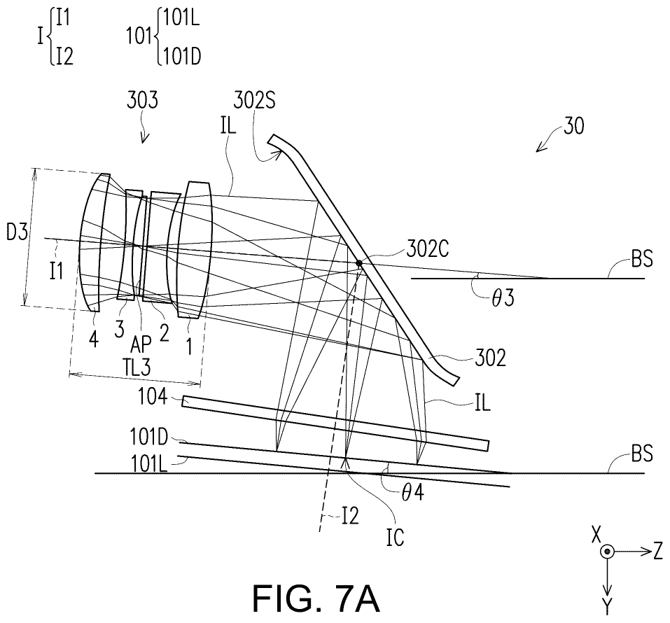

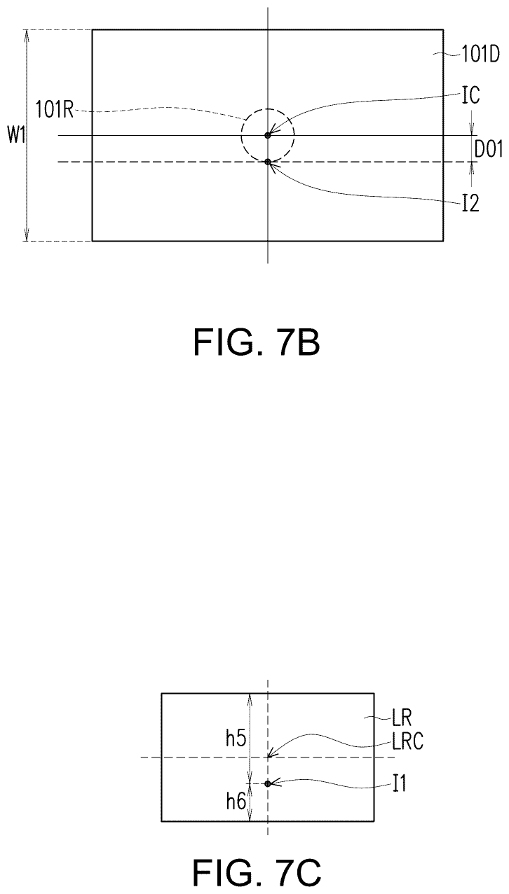

FIG. 7A is a schematic side-view diagram of the projection device in accordance with the third embodiment of the disclosure. FIG. 7B is a schematic diagram of the configuration of the display panel in FIG. 7A. FIG. 7C is a schematic diagram of an imaging-beam region generated by the projection device in FIG. 7A.

Please refer to FIG. 1A, FIG. 7A, FIG. 7B, and FIG. 7C. According to the third embodiment of the disclosure, a projection device 30 including an imaging module 101, a Fresnel lens element 104, a freeform-surface reflective mirror 302, and a projection lens assembly 303 is provided. The imaging module 101 includes a display panel 101D and a light-source module 101L, in which the display panel 101D is disposed between the light-source module 101L and the freeform-surface reflective mirror 302. The imaging module 101 is used to provide imaging beams IL. The freeform-surface reflective mirror 302 is disposed on the path of the imaging beams IL. The imaging beams IL is transmitted toward the projection lens assembly 303 by the freeform-surface reflective mirror 302 and transmitted out the projection device 30 after passing through the projection lens assembly 303.

The projection lens assembly 303 has an optical axis I. The optical axis I includes a first optical axis I1 and a second optical axis I2. The second optical axis I2 deflects relative to the first optical axis I1 at the freeform-surface reflective mirror 302 (for example, the second optical axis I2 deflects relative to the first optical axis I1 at a geometric center 302C of the freeform-surface reflective mirror 302), which means that the first optical axis I1 is a part of the optical axis I before the deflection, and the second optical axis I2 is a part of the optical axis I after the deflection at the freeform-surface reflective mirror 302. The first optical axis I1 passes through the projection lens assembly 303 and is selectively tilted by an angle θ3 relative to a base surface BS. The base surface BS may be, for example, a horizontal plane parallel to the X-Z plane (a plane perpendicular to the direction of gravity, for example, suitable for an upright-type projection mode or configuration), or a plane parallel to a base plate of the projection device 30, in which the light-source module 101L is disposed on the base plate. The plane on which the display panel 101D (for example, a display surface of the display panel 101D) is positioned is selectively tilted by an angle θ4 relative to the base surface BS. In an embodiment, the base plate is perpendicular to, for example, a projection surface IM (e.g., a projection screen), but the disclosure is not limited thereto. The distortion of projected image caused by the tilt of the first optical axis I1 and the tilt of the display panel 101D relative to the base surface BS would be compensated by the modification to the imaging beams IL via the freeform-surface reflective mirror 302.

It should be noted that, referring to FIG. 7A and FIG. 7B, the image generated by the display panel 101D is misaligned with the second optical axis I2 (i.e., the display panel 101D is misaligned with the second optical axis I2) in the present embodiment. Specifically, the second optical axis I2 does not pass through the geometric center IC of the display panel 101D (for example, the display surface), but passes through the geometric center region 101R of the display panel 101D. The geometric center region 101R is a region having a distance D01 less than or equal to 40% of a minimum width W1 of the display panel 101D from a geometric center IC of the display panel 101D (for example, greater than 0% and less than or equal to 40%). In other embodiments, the geometric center region 101R is a region having a distance D01 less than or equal to 10% of a minimum width W1 of the display panel 101D from a geometric center IC of the display panel 101D. The geometric center IC of the display panel 101D indicates the center of the image generated by the display panel 101D (e.g., a center of a display surface of the display panel 101D). It should be noted that, if the distance between the geometric center IC of the display panel 101D and the second optical axis I2 (for example, the distance D01) resulted from the misalignment is greater than 10% of the minimum width W1 of the display panel 101D, the size and weight of the projection lens assembly 303 might slightly increase. If the distance between the geometric center IC of the display panel 101D and the second optical axis I2 (for example, the distance D01) resulted from the misalignment is greater than 40% of the minimum width W1 of the display panel 101D, the size and weight of the projection lens assembly 303 might significantly increase.

In the present embodiment, since the second optical axis I2 may selectively pass through the geometric center region 101R of the display panel 101D, the angle θ3 at which the first optical axis I1 is tilted relative to the base surface BS and the angle θ4 at which the plane where the display panel 101D is positioned is tilted relative to the base surface BS satisfying the conditional expression 0.073<|θ3/θ4|<0.5 (for example, the angle θ3 is 1.45 degrees, the angle θ4 is 9.4 degrees, and the distance D01 is 10% of the minimum width W1 of the display panel 101D) may achieve the projected off-axis image. In some embodiments, the angle θ3 is within a range of 0.8 degrees to 2.5 degrees, and the angle θ4 is within a range of 5 degrees to 11 degrees. In this manner, since the angle θ3 is small, the projection lens assembly 303 would not significantly tilt inward when viewed from outside of the projection device 30 toward inside of the projection device 30.

Referring to FIG. 1A, FIG. 7A and FIG. 7C, the imaging beams IL emitted by the projection device 30 forms an imaging-beam region LR on a cross-section plane 99 perpendicular to the first optical axis I1, the first optical axis I1 may not pass through a geometric center LRC of the imaging-beam region LR, as shown in FIG. 1A and FIG. 7C. A height h5 of the imaging-beam region LR above the first optical axis I1 is greater than a height h6 of the imaging-beam region LR below the first optical axis I1. For example, a ratio of h5 and (h5+h6) may be within a range of 60% to 100%. This is the modification to the imaging beams IL via the tilt angle θ3 of the first optical axis I1, the tilt angle θ4 of the display panel 101D and the design of the freeform-surface reflective mirror 302. That is to say, when the projection device 30 according to this embodiment is used to generate an image projected onto the projection surface IM (e.g., the projection screen), the distortion of projected image caused by the angle θ3 at which the first optical axis I1 is tilted relative to the base surface BS and the angle θ4 at which the plane where the display panel 101D is positioned is tilted relative to the base surface BS would be compensated by the modification to the imaging beams IL via the freeform-surface reflective mirror 302.

The projection device 30 may also include a Fresnel lens element 104, which is disposed between the display panel 101D and the freeform-surface reflective mirror 302. The projection device 30 is, for example, a telecentric system, wherein the first optical axis I1 and the second optical axis I2 each have an included angle of 45 degrees with the normal line of the freeform-surface reflective mirror 302 (for example, a plane at the center), and an optical axis of the Fresnel lens element 104 is parallel to the second optical axis I2. In some embodiments, the included angle between the plane where the Fresnel lens element 104 (for example, the light-emitting surface) is positioned and the plane where the display panel 101D (for example, the display surface) is positioned is greater than −30 degrees and less than 30 degrees. In other embodiments, the plane where the Fresnel lens element 104 is positioned is parallel to the plane where the display panel 101D is positioned.

In this embodiment, the included angle between the second optical axis I2 and the tangent plane of the geometric center 302C of the reflection surface 302S of the freeform-surface reflective mirror 302 is within a range of greater than or equal to 20 degrees or less than or equal to 60 degrees, for example, 45 degrees. That is to say, when a light beam is incident on the geometric center 302C of the freeform-surface reflective mirror 302 along the second optical axis I2, the light beam is incident on the reflection surface 302S at an incident angle of 45 degrees. However, the disclosure is not limited thereto, and the included angle may be changed according to the structure of the projection device 30.

For example, the projection lens assembly 303 includes a first lens element 1, a second lens element 2, a third lens element 3, and a fourth lens element 4 in a sequence from the object side to the image side (for example, the projection lens assembly 303 is composed of the first lens element 1, the second lens element 2, the third lens element 3, and the fourth lens element 4), and none of the four lens elements are formed as a glued lens element. It should be noted that, since the projected off-axis image is achieved through the tilt arrangement of the projection lens assembly 303 and the display panel 101D according to the disclosure, the proportional relationship between the size of the lens elements and the length of the projection lens assembly 303 may be maintained. For example, a distance between an object side of the first lens element 1 and an image side of the fourth lens element 4 on the first optical axis I1 is TL3, a diameter of the one with the largest diameter among the first lens element 1 to the fourth lens element 4 is D3, and the projection lens assembly 303 satisfies the conditional expression 0.7<|TL3/D3|<1.2.

It should be noted that, the disclosure is not only suitable for the telecentric system shown in FIG. 1A and FIG. 7A, but also suitable for different optical systems. In an embodiment not depicted, the projection device 30 does not include a Fresnel lens element 104, and is a non-telecentric system.

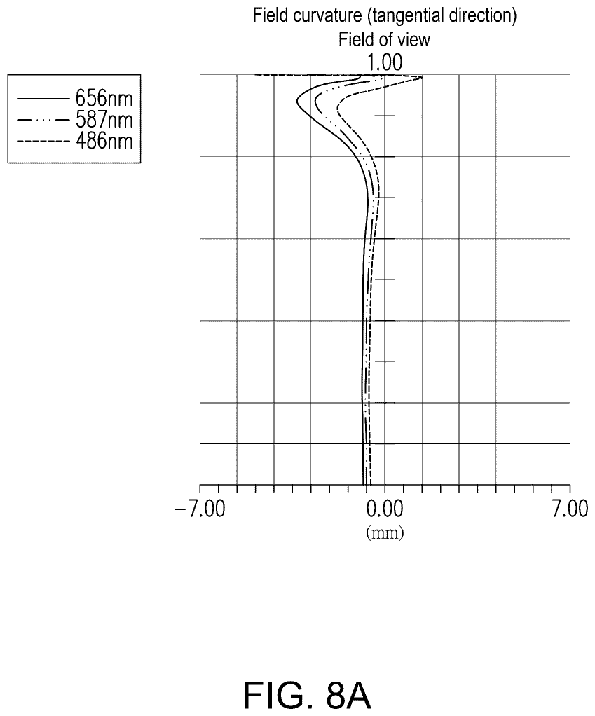

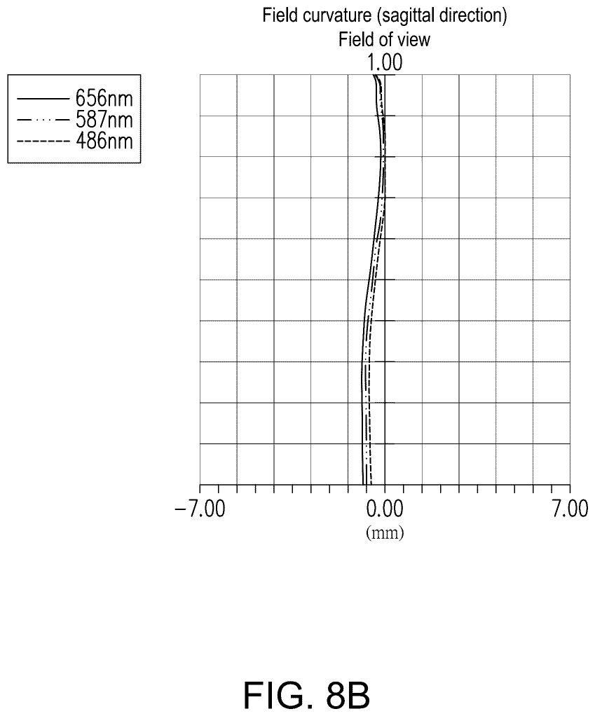

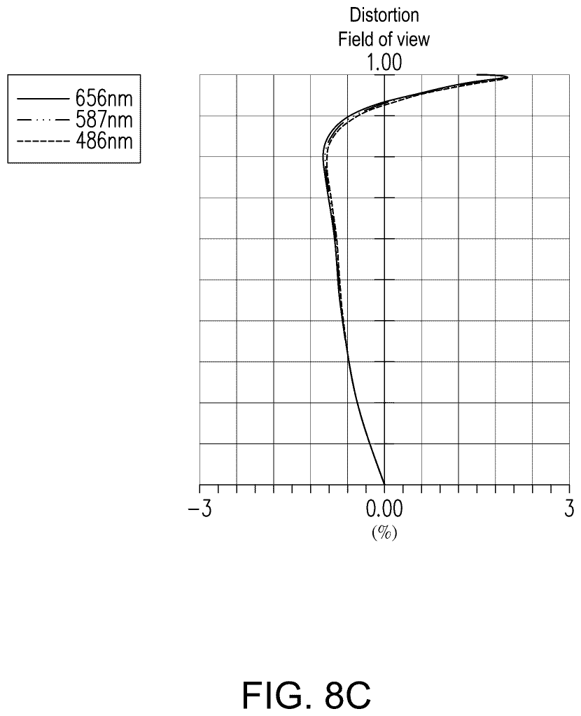

Referring to FIG. 8A, FIG. 8B, and FIG. 8C, FIG. 8A and FIG. 8B are respectively schematic diagrams of a field curvature aberration in a tangential direction and a field curvature aberration in a sagittal direction of the projection device 30 with wavelengths of 656 nm, 587 nm, and 486 nm. FIG. 8C is a schematic diagram of a distortion aberration of the projection device 30 with wavelengths of 656 nm, 587 nm, and 486 nm. In the two field curvature aberration diagrams (FIG. 8A and FIG. 8B), the field curvature aberration of the three representative wavelengths are within a range of ±7 mm for the entire field of view, indicating that the projection device 30 can effectively eliminate the field curvature aberration. The distortion aberration diagram in FIG. 8C shows that the distortion aberration is maintained within a range of ±3%, indicating that the projection device 30 can provide a good image quality.

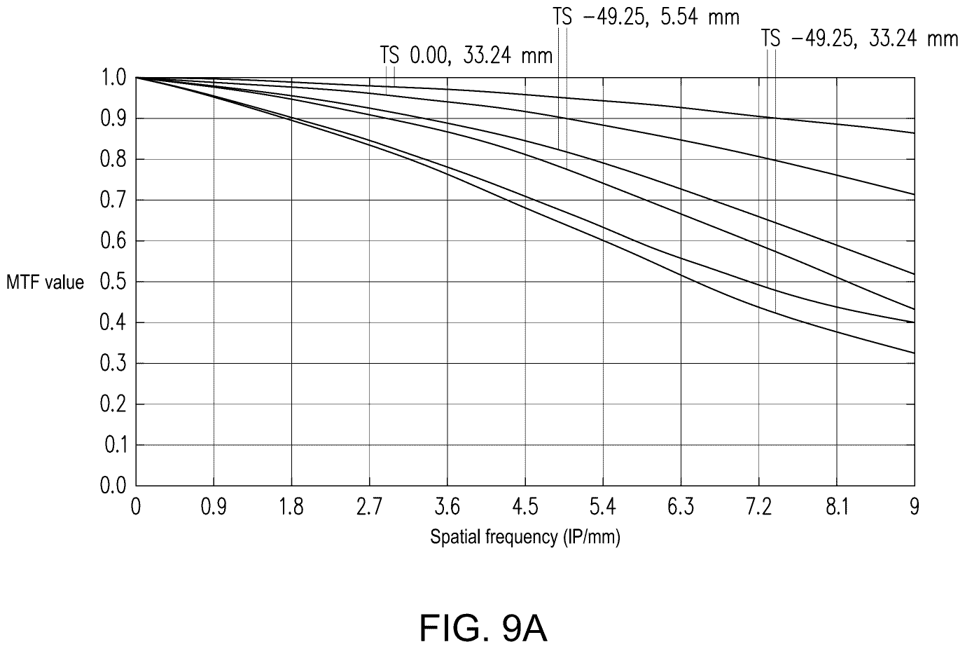

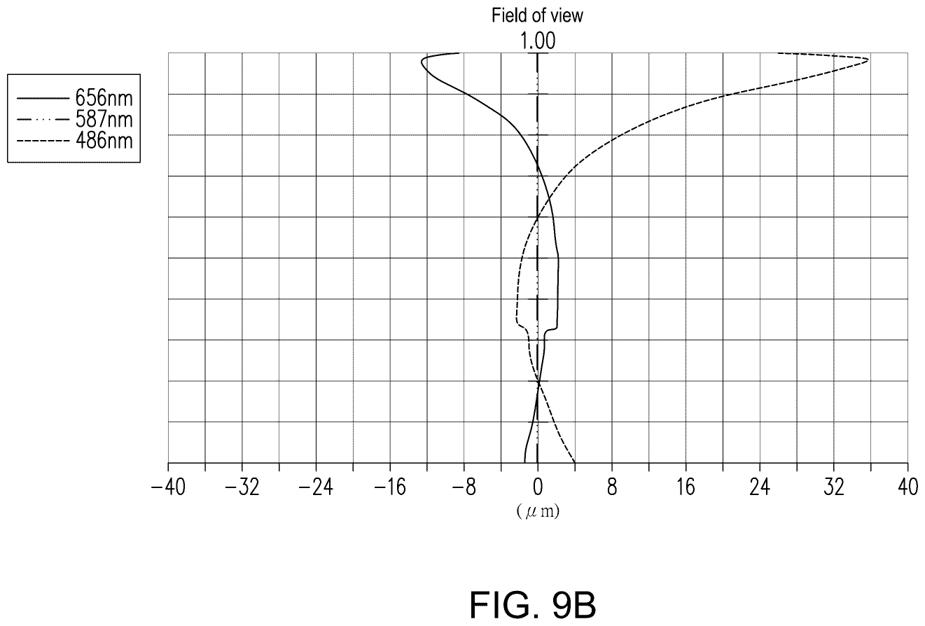

Referring to FIG. 9A, which is a schematic diagram of MTF (modulation transfer function) at multiple positions (for example, a center position, a lower left position, and an upper right position) of the projection device according to the third embodiment of the disclosure. It is seen that the MTF value at each position of the projection device 30 according to the third embodiment of the disclosure is greater than 0.33, and a good optical performance is provided. Refer to FIG. 9B, which is a schematic diagram of lateral chromatic aberration of the projection device 30 according to the third embodiment of the disclosure. As shown in FIG. 9B, the maximum displacement of the red rays and the blue rays is 471 μm.

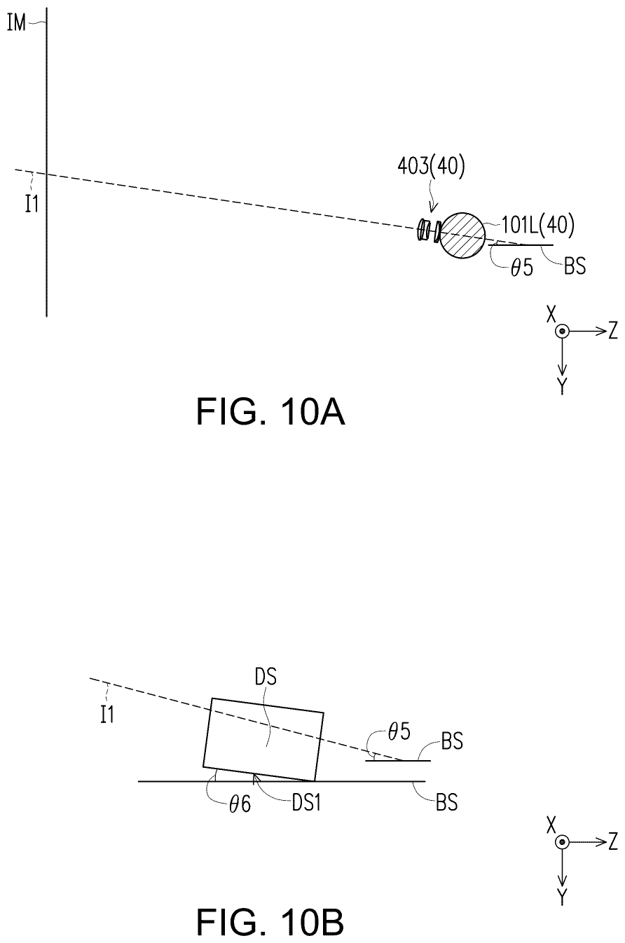

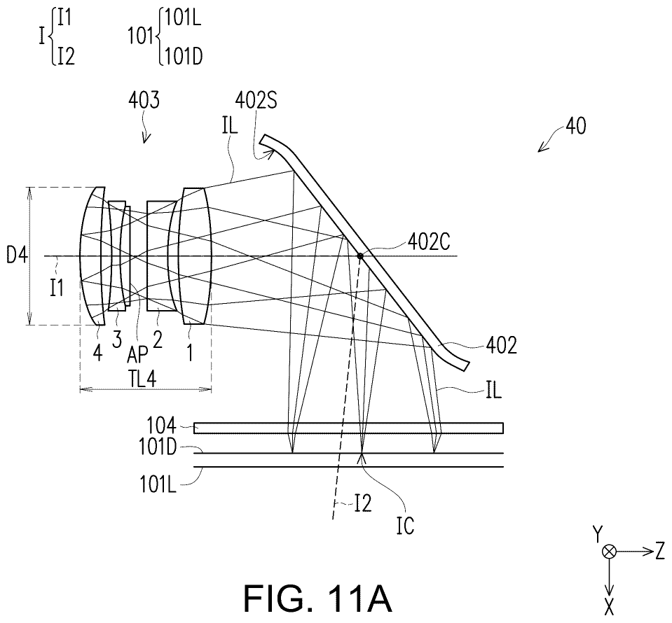

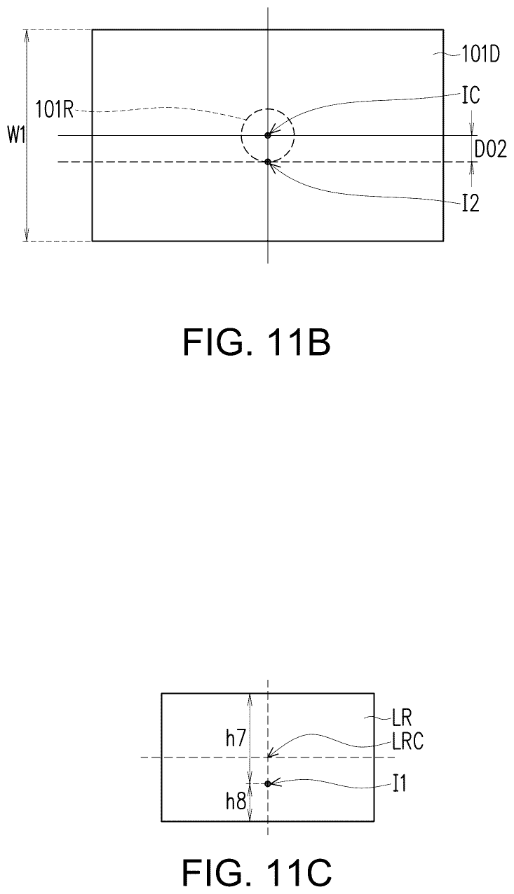

FIG. 10A and FIG. 10B are schematic diagrams of a status of use of a projection device according to an embodiment of the disclosure. FIG. 11A is a schematic top-view diagram of the projection device in accordance with the fourth embodiment of the disclosure. FIG. 11B is a schematic diagram of the configuration of the display panel in FIG. 11A. FIG. 11C is a schematic diagram of an imaging-beam region generated by the projection device in FIG. 11A. It is noted that, in order to clearly indicate the corresponding relationship between the first optical axis I1 of the projection lens assembly and the projected image, the projection device 40 depicted in FIG. 10A merely contains the projection lens assembly 403 and the light-source module 101L, and other elements of the projection device 40 are omitted. In order to clearly indicate the corresponding relationship between the display panel 101D and the base surface BS, the projection device 40 depicted in FIG. 10B merely contains the projection lens assembly 403 and the display panel 101D, and other elements of the projection device 40 are omitted.

Please refer to FIG. 10A, FIG. 10B, FIG. 11A, FIG. 11B, and FIG. 11C. According to the fourth embodiment of the disclosure, a projection device 40 including an imaging module 101, a Fresnel lens element 104, a freeform-surface reflective mirror 402, and a projection lens assembly 403 is provided. The imaging module 101 includes a display panel 101D and a light-source module 101L, in which the display panel 101D is disposed between the light-source module 101L and the freeform-surface reflective mirror 402. The imaging module 101 is used to provide imaging beams IL. The freeform-surface reflective mirror 402 is disposed on the path of the imaging beams IL. The imaging beams IL is transmitted toward the projection lens assembly 403 by the freeform-surface reflective mirror 402 and emitted by the projection device 40 after passing through the projection lens assembly 403.

The projection lens assembly 403 has an optical axis I. The optical axis I includes a first optical axis I1 and a second optical axis I2. The second optical axis I2 deflects relative to the first optical axis I1 at the freeform-surface reflective mirror 402 (for example, the second optical axis I2 deflects relative to the first optical axis I1 at a geometric center 402C of the freeform-surface reflective mirror 402), which means that the first optical axis I1 is a part of the optical axis I before the deflection, and the second optical axis I2 is a part of the optical axis I after the deflection at the freeform-surface reflective mirror 402. The first optical axis I1 passes through the projection lens assembly 403 and is selectively tilted by an angle θ5 relative to a base surface BS. The base surface BS may be, for example, a horizontal plane parallel to the X-Z plane (a plane perpendicular to the direction of gravity, for example, suitable for a lying-type projection mode or configuration), or a plane parallel to a base plate of the projection device 40, in which the light-source module 101L is disposed on the base plate. The display panel 101D (for example, a display surface DS of the display panel 101D) is selectively tilted (rotated) by an angle θ6 relative to the base surface BS. Further, the display surface DS of the display panel 101D is, for example, rectangular and has a side DS1. The included angle between the side DS1 and the base surface BS is the angle θ6. The distortion of projected image caused by the tilt of the first optical axis I1 and the tilt of the display panel 101D relative to the base surface BS would be compensated by the modification to the imaging beams IL via the freeform-surface reflective mirror 402.

In the present embodiment, the angle θ5 at which the first optical axis I1 is tilted relative to the base surface BS and the angle θ6 at which the display panel 101D is tilted (rotated) relative to the base surface BS satisfy the conditional expression 0.33<|θ5/θ6|<15. In some embodiments, the angle θ5 is within a range of 0.5 degrees to 3 degrees, and the angle θ6 is within a range of 0.2 degrees to 1.5 degrees. Since the angle θ5 is small, the projection lens assembly 403 would not tilt inward when viewed from outside of the projection device 40 toward inside of the projection device 40. The tilt (rotated) angle θ6 may effectively benefit the compensation for the distortion of projected image caused by the tilt angle θ5 of the first optical axis I1 relative to the base surface BS.

It should be noted that, referring to FIG. 11A and FIG. 11B, the display panel 101D may be misaligned with the second optical axis I2 in the present embodiment. Specifically, the second optical axis I2 does not pass through the geometric center IC of the display panel 101D, but passes through the geometric center region 101R of the display panel 101D. The geometric center region 101R is a region having a distance D02 less than or equal to 40% of a minimum width W1 of the display panel 101D from a geometric center IC of the display panel 101D (for example, greater than 0% and less than or equal to 40%). In other embodiments, the geometric center region 101R is a region having a distance D02 less than or equal to 10% of a minimum width W1 of the display panel 101D from a geometric center IC of the display panel 101D. The geometric center IC of the display panel 101D indicates the center of the image generated by the display panel 101D.

Referring to FIG. 10, FIG. 11A and FIG. 11C, the imaging beams IL emitted by the projection device 40 forms an imaging-beam region LR on a cross-section plane 99 perpendicular to the first optical axis I1, the first optical axis I1 may not pass through a geometric center LRC of the imaging-beam region LR, as shown in FIG. 10 and FIG. 11C. A height h7 of the imaging-beam region LR above the first optical axis I1 is greater than a height h8 of the imaging-beam region LR below the first optical axis I1. A ratio of h7 and (h7+h8) may be within a range of 60 25% to 100%. This is the modification to the imaging beams IL via the tilt angle θ5 of the first optical axis I1, the tilt angle θ6 of the display panel 101D and the design of the freeform-surface reflective mirror 402. That is to say, when the projection device 40 according to this embodiment is used to generate an image projected onto the projection surface IM (the projection screen), the distortion of projected image caused by the angle θ5 at which the first optical axis I1 is tilted relative to the base surface BS and the angle θ6 at which the display panel 101D is tilted relative to the base surface BS would be compensated by the modification to the imaging beams IL via the freeform-surface reflective mirror 402.

The projection device 40 may also include a Fresnel lens element 104, which is disposed between the display panel 101D and the freeform-surface reflective mirror 402. The projection device 40 is, for example, a telecentric system, wherein the first optical axis I1 and the second optical axis I2 each have an included angle of 45 degrees with the normal line of the freeform-surface reflective mirror 402, and an optical axis of the Fresnel lens element 104 is parallel to the second optical axis I2. In some embodiments, the included angle between the plane where the Fresnel lens element 104 (for example, the light-emitting surface) is positioned and the plane where the display panel 101D (for example, the display surface) is positioned is greater than −30 degrees and less than 30 degrees. In other embodiments, the plane where the Fresnel lens element 104 is positioned is parallel to the plane where the display panel 101D is positioned.

In this embodiment, the included angle between the second optical axis I2 and the tangent plane of the geometric center 402C of the reflection surface 402S of the freeform-surface reflective mirror 402 is within a range of greater than or equal to 20 degrees or less than or equal to 60 degrees, for example, 45 degrees. That is to say, when a ray is incident on the geometric center 402C of the freeform-surface reflective mirror 402 along the second optical axis I2, the ray is incident on the reflection surface 402S at an incident angle of 45 degrees. However, the disclosure is not limited thereto, and the included angle may be changed according to the structure of the projection device 40.

For example, the projection lens assembly 403 includes a first lens element 1, a second lens element 2, a third lens element 3, and a fourth lens element 4 in a sequence from the object side to the image side (for example, the projection lens assembly 403 is composed of the first lens element 1, the second lens element 2, the third lens element 3, and the fourth lens element 4). Further, three lens elements among the four lens elements are glass lens elements, and the other lens element is an aspherical plastic lens element. It should be noted that, since the projected off-axis image is achieved through the tilt arrangement of the projection lens assembly 403 and the display panel 101D according to the disclosure, the proportional relationship between the size of the lens elements and the length of the projection lens assembly 403 may be maintained. For example, a distance between an object side of the first lens element 1 and an image side of the fourth lens element 4 on the first optical axis I1 is TL4, a diameter of the one with the largest diameter among the first lens element 1 to the fourth lens element 4 is D4, and the projection lens assembly 403 satisfies the conditional expression 0.7<|TL4/D4|<1.5.

It should be noted that, the disclosure is not only suitable for the telecentric system shown in FIG. 10 and FIG. 11A, but also suitable for different optical systems. In an embodiment not depicted, the projection device 40 does not include a Fresnel lens element 104, and is a non-telecentric system.

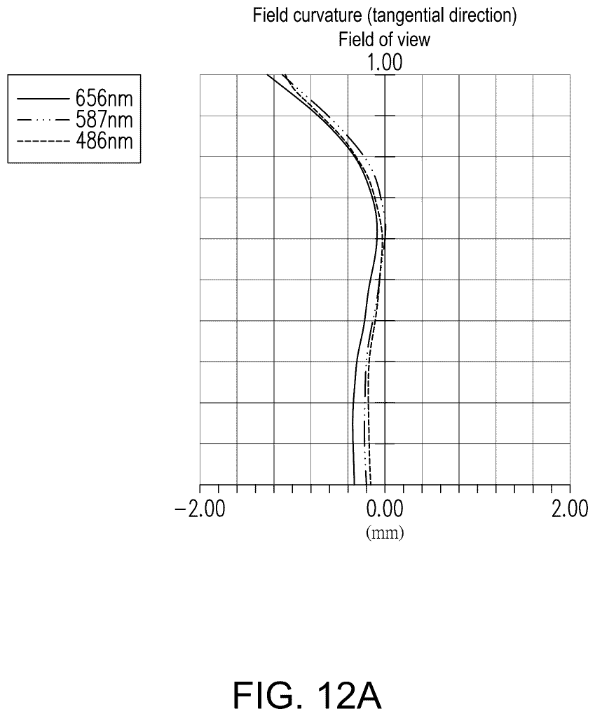

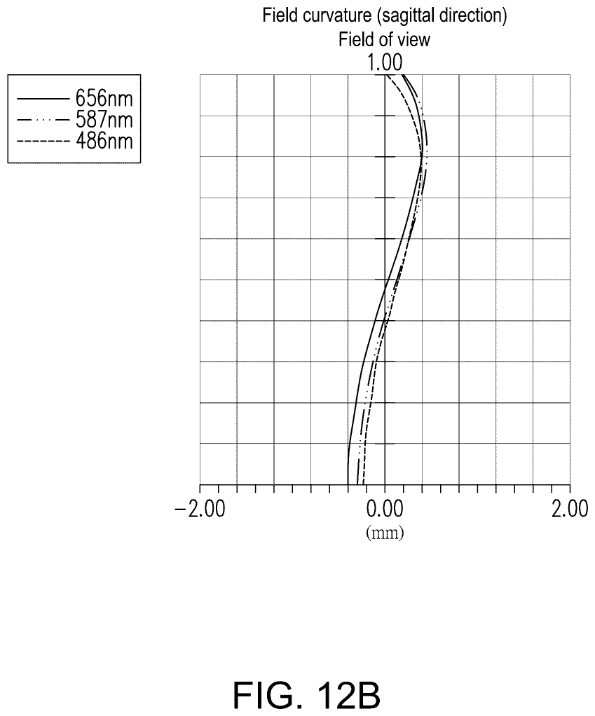

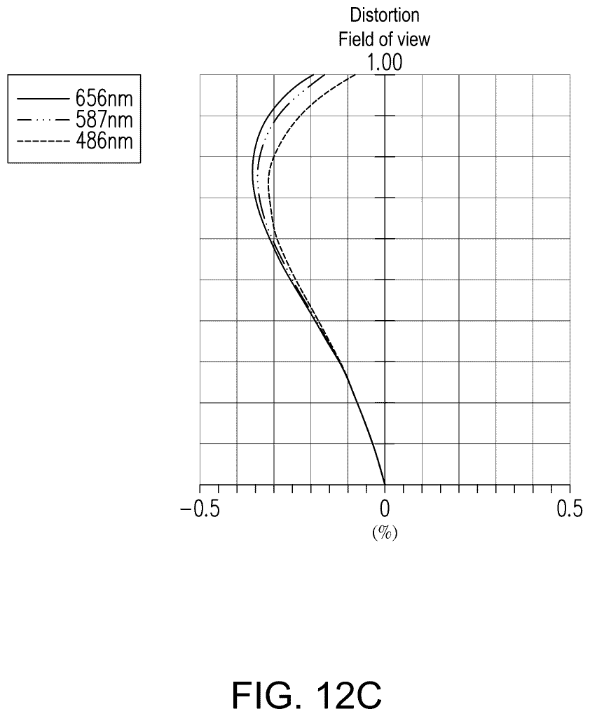

Referring to FIG. 12A, FIG. 12B, and FIG. 12C, FIG. 12A and FIG. 12B are respectively schematic diagrams of a field curvature aberration in a tangential direction and a field curvature aberration in a sagittal direction of the projection device 40 with wavelengths of 656 nm, 587 nm, and 486 nm. FIG. 12C is a schematic diagram of a distortion aberration of the projection device 40 with wavelengths of 656 nm, 587 nm, and 486 nm. In the two field curvature aberration diagrams (FIG. 12A and FIG. 12B), the field curvature aberration of the three representative wavelengths are within a range of ±2 mm for the entire field of view, indicating that the projection device 40 can effectively eliminate the field curvature aberration. The distortion aberration diagram in FIG. 12C shows that the distortion aberration is maintained within a range of ±0.5%, indicating that the projection device 40 can provide a good image quality.

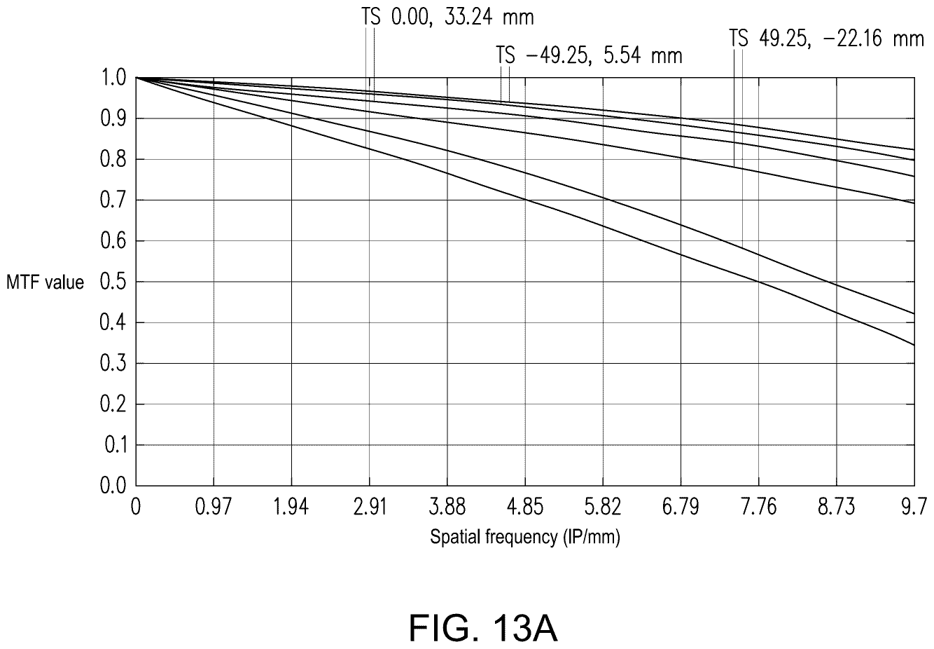

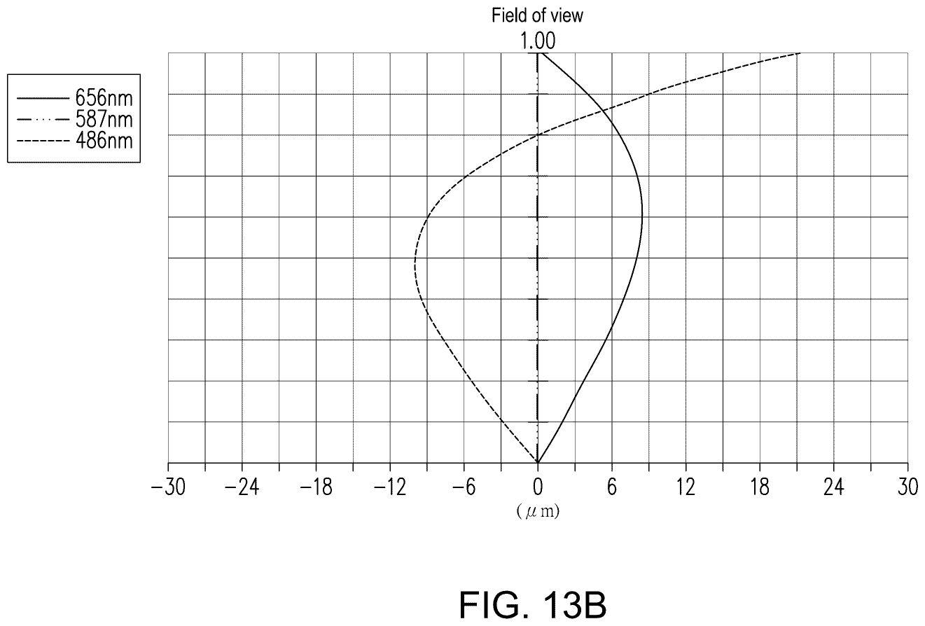

Referring to FIG. 13A, which is a schematic diagram of MTF (modulation transfer function) at multiple positions (for example, a center position, a lower left position, and an upper right position) of the projection device according to the fourth embodiment of the disclosure. It is seen that the MTF value at each position of the projection device 40 according to the fourth embodiment of the disclosure is greater than 0.34, and a good optical performance is provided. Refer to FIG. 13B, which is a schematic diagram of lateral chromatic aberration of the projection device 40 according to the fourth embodiment of the disclosure. As shown in FIG. 13B, the maximum displacement of the red rays and the blue rays is 21 μm.

In summary, the projection device provided by the embodiment of the disclosure uses the freeform-surface reflective mirror to improve the degree of design freedom. The lens element in the projection lens assembly does not need to be configured in an off-axis manner Moreover, when the imaging module and the projection lens assembly are tilted, there is no distortion or resolution degradation issues of the projected image, and the projection device does not need to be elevated to a specific height for use.

However, the above are merely the preferred embodiments according to the disclosure, and should not be used to limit the scope of the disclosure. That is, any simple equivalent changes and modifications made based on the patent scope of the disclosure and the description of the disclosure are still within the scope of protection of the disclosure. In addition, any embodiment or claim of the disclosure does not need to achieve all the purposes, advantages, or features disclosed in the disclosure. In addition, the abstract section and title are merely used to assist in searching patent documents and are not intended to limit the scope of the disclosure. In addition, the terms “first” and “second” mentioned in this specification or the appended claims are merely used to name an element or to distinguish different embodiments or scopes, and are not used to limit the upper limit or lower limit of the quantity of elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising:
an imaging module comprising a display panel and a light-source module, wherein the imaging module is configured to provide imaging beams;
a freeform-surface reflective mirror disposed on a path of the imaging beams; and
a projection lens assembly, wherein the imaging beams are transmitted toward the projection lens assembly via the freeform-surface reflective mirror, and the imaging beams are emitted by the projection device after passing through the projection lens assembly,
wherein the projection lens assembly has an optical axis, the optical axis comprises a first optical axis and a second optical axis, the second optical axis deflects relative to the first optical axis at the freeform-surface reflective mirror, the first optical axis passes through the projection lens assembly, the imaging beams emitted by the projection device form an imaging-beam region on a cross-section plane perpendicular to the first optical axis, the first optical axis does not pass through a geometric center of the imaging-beam region, and the second optical axis passes through a geometric center region of the display panel, wherein the geometric center region is a region having a distance less than or equal to 40% of a minimum width of the display panel from a geometric center of the display panel.

2. The projection device as claimed in claim 1, wherein the second optical axis passes through the geometric center of the display panel.

3. The projection device as claimed in claim 1, wherein the first optical axis is tilted by an angle θ1 relative to a base surface, and a plane on which the display panel is positioned is tilted by an angle θ2 relative to the base surface, and the angle θ1 and the angle θ2 satisfies a conditional expression 0.7<|θ1/θ2|<1.5.

4. The projection device as claimed in claim 3, further comprises a base plate, wherein the light-source module is disposed on the base plate, and the base surface is parallel to the base plate.

5. The projection device as claimed in claim 3, wherein the angle θ1 is within a range of 0.5 degrees to 6 degrees.

6. The projection device as claimed in claim 3, wherein the angle θ2 is within a range of 0.5 degrees to 7.5 degrees.

7. The projection device as claimed in claim 3, wherein a difference between the angle θ1 and the angle θ2 is greater than −4 degrees and less than 4 degrees.

8. The projection device as claimed in claim 1, wherein an angle θ3 at which the first optical axis is tilted relative to a base surface and an angle θ4 at which a plane where the display panel is positioned is tilted relative to the base surface satisfy a conditional expression 0.073<|θ3/θ4|<0.5.

9. The projection device as claimed in claim 8, wherein the angle θ3 is within a range of 0.8 degrees to 2.5 degrees.

10. The projection device as claimed in claim 8, wherein the angle θ4 is within a range of 5 degrees to 11 degrees.

11. The projection device as claimed in claim 1, wherein an angle θ5 at which the first optical axis is tilted relative to a base surface and an angle θ6 at which the display panel is rotated relative to the base surface satisfy a conditional expression 0.33<θ5/θ6|<15.

12. The projection device as claimed in claim 11, wherein the angle θ5 is within a range of 0.5 degrees to 3 degrees.

13. The projection device as claimed in claim 11, wherein the angle θ6 is within a range of 0.2 degrees to 1.5 degrees.

14. The projection device as claimed in claim 1, wherein the freeform-surface reflective mirror is symmetrical with respect to a first plane and asymmetrical with respect to a second plane, the first optical axis and the second optical axis are positioned on the first plane, and the second plane is perpendicular to the first plane.

15. The projection device as claimed in claim 1 further comprises a Fresnel lens element disposed between the display panel and the freeform-surface reflective mirror, wherein an optical axis of the Fresnel lens element is parallel to the second optical axis.

16. The projection device as claimed in claim 1, wherein an included angle between the second optical axis and a tangent plane of a geometric center of the freeform-surface reflective mirror is greater than or equal to 20 degrees and less than or equal to 60 degrees.

17. The projection device as claimed in claim 1, wherein the projection lens assembly comprises a first lens element, a second lens element, a third lens element, and a fourth lens element in a sequence from an object side to an image side, and the first lens element and the second lens element are formed as a glued lens element.

18. The projection device as claimed in claim 17, wherein a distance between an object-side surface of the first lens element and an image-side surface of the fourth lens element on the first optical axis is TL1, a diameter of the lens element among the first lens element to the fourth lens element having a largest diameter is D1, and the projection lens assembly satisfies a conditional expression 0.7<|TL1/D1|<1.5.

19. The projection device as claimed in claim 1, wherein the projection device is an upright-type projection device.

20. The projection device as claimed in claim 1, wherein the projection device is a lying-type projection device.
